(19) United States
(12) Patent Application Publication
(10) Pub. No.: US 2016/0042428 A1
(43) Pub. Date: Feb. 11, 2016

(54) PERSONALIZED PRODUCT RECOMMENDATION BASED ON BRAND PERSONALITY SCALE

(71) Applicant: International Business Machines Corporation, Armonk, NY (US)

(72) Inventors: Liang Gou, San Jose, CA (US); Aditya Pal, San Jose, CA (US); Fei Wang, Fremont, CA (US); Michelle X. Zhou, Saratoga, CA (US)

(21) Appl. No.: 14/453,081

(22) Filed: Aug. 6, 2014

(51) Int. Cl. G06Q 30/06; G06N 99/00

(52) U.S. Cl. CPC G06Q 30/0631; G06N 99/005

(57) ABSTRACT

Brands and users are matched by determining their personalities and pairing them based on user-brand associations. Modeling parameters are estimated based on the personalities of each pair. Additional pairs of users and brands having unknown associations are identified, and each such additional pair's correlation, which may be a score, is determined, based on the modelling parameters. Brands and users having unknown associations are matched based on their correlations scores matching one or more criteria.

### FIELD OF THE INVENTION

The present disclosure generally relates to computer systems, and more particularly to matching products to users in ecommerce environments.

### BACKGROUND

“Brand personality” may refer to a set of characteristics or attributes of a brand and/or products or services offered by a provider, using personalities or characteristics typically associated with a user. The greater the correlation between user characteristics that consistently and distinctively describe the user's actual or ideal identity, and those that describe a brand, product, or service, the greater the likelihood may be that the user will prefer the brand to other brands.

### BRIEF SUMMARY

It may be desirable to implement a method, system, and computer program product that utilize personalities associated with a brand, product, or service, to match the brand, product, or service to one or more users.

Embodiments of the present disclosure provide a method, system, and computer program product for matching brands to users on a computer system. The matching may include determining personalities of a set of users and of a set of brands and identifying a first set of user-brand pairs. Elements of each pair in the first set of user-brand pairs have known associations. One or more modelling parameters may be estimated based on the first set of user-brand pairs, and a second set of user-brand pairs may be identified, where elements of each pair in the second set of user-brand pairs have unknown associations. Correlations may be determined between elements of one or more pairs in the second set of user-brand pairs based on the modelling parameters. Based on the correlations, a select set of brands whose corresponding correlation to a given user satisfies a first threshold criteria may be matched. Additionally, or alternatively, a select set of users whose corresponding correlation to a given brand satisfies a second threshold criteria may be matched. The first and second threshold values may be identical or different.

### BRIEF DESCRIPTION OF THE SEVERAL VIEWS OF THE DRAWINGS

FIG. 1 depicts an exemplary computer system for matching brands to users, according to an aspect of the present disclosure.

FIG. 2 is a flow chart depicting steps of a method according to an aspect of the present disclosure.

FIG. 3 is a flowchart depicting steps of a method for a brand-centric matching of a brand, product, or service to a user, according to an embodiment of the present invention.

FIG. 4 is a flowchart depicting steps of a method for a user-centric matching of a brand, product, or service to a user, according to an embodiment of the present invention.

FIG. 5 is a flowchart depicting steps of a method for recommending groups of users to one or more brands based on their respective group attributes, according to an embodiment of the present invention.

FIG. 6 is a schematic block diagram of a computer system, according to an aspect of the present disclosure.

FIG. 7 is a schematic block diagram of an illustrative cloud computing environment, according to an aspect of the present disclosure.

FIG. 8 is a multi-layered functional illustration of the cloud computing environment depicted in FIG. 7, according to an aspect of the present disclosure.

### DETAILED DESCRIPTION

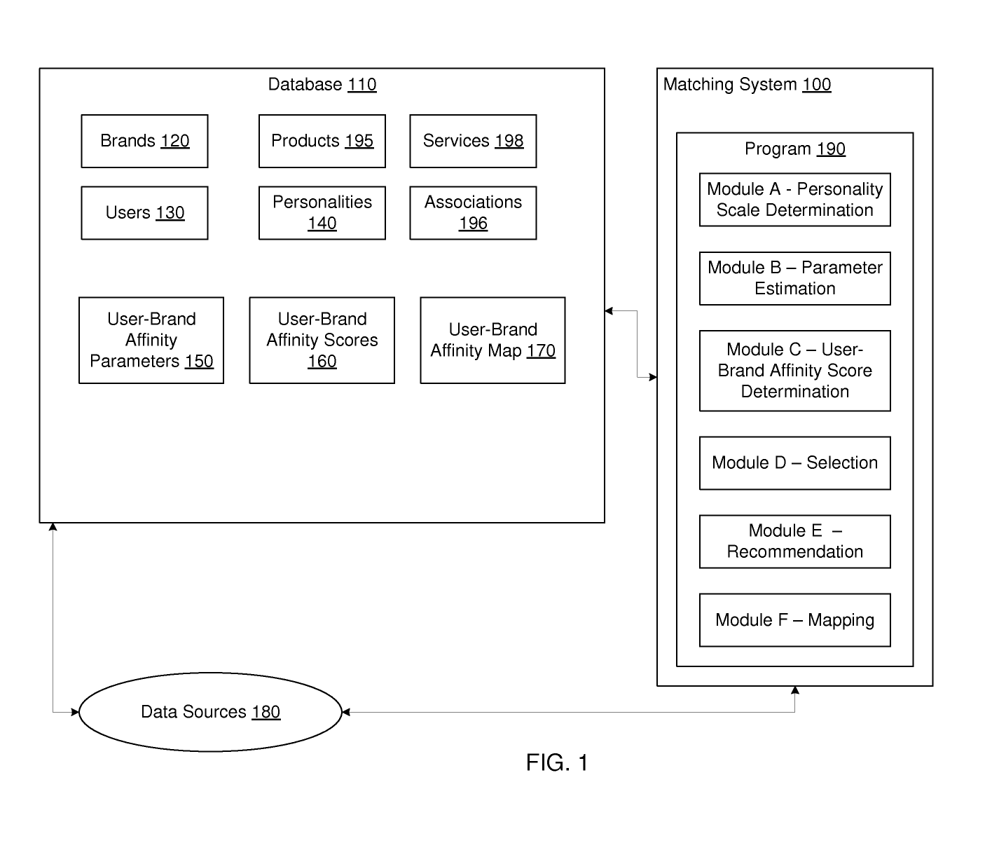

FIG. 1 depicts an exemplary computer system 100 (“Matching System 100”) for matching brands, products, or services, or a combination thereof, to one or more users, based on their respective personality scales, according to an aspect of the present disclosure. A brand may correspond to a source of one or more products or services. In an embodiment, the source associated with the brand may be a commercial business. In one example, such business may be an online retailer offering a set of products and/or services via a website. A personality, or personality scale, of the brand, product, or service may include traits, characteristics, or properties that are associated with and describe the brand, product, or service. The traits, characteristics, or properties of the personality scale may include ones that are typically associated with a person.

The following description of embodiments of the present invention includes references to brands, and to matching brands with users, based on their respective personality scales. It will be apparent to a person of ordinary skill in the art that the description also applies to embodiments that match products or service to users, based on their respective personality scales. Therefore, in the following description and in the following claims, unless otherwise stated, “brand” shall refer to one or more of “brand”, “product”, and “service”.

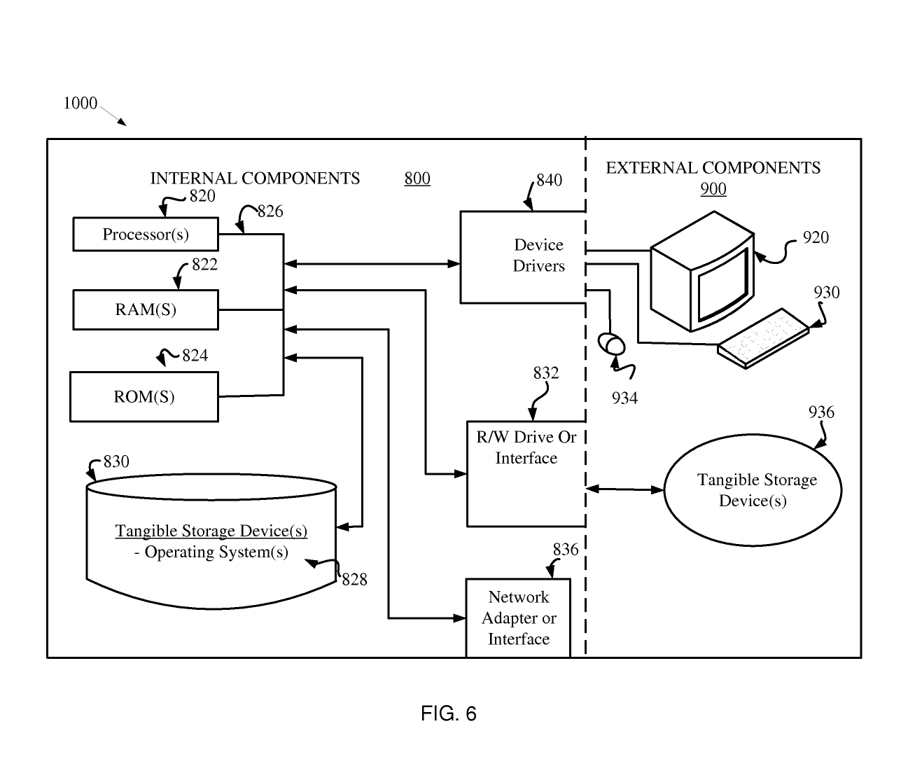

The Matching System 100 may be embodied as one or more devices such as a computer or a server. Multiple such devices may be operatively connected in a communications environment, such as an Intranet network, the Internet, or a cloud computing environment. The Matching System 100 may be operatively connected to one or more internal or external Database(s) 110, which may include one or more tangible storage devices. Additional details of the physical structures of and connections between the Matching System 100 and the Database 110, as well as other devices or systems, are described in greater detail in connection with FIGS. 6-8, below.

The Matching System 100 may include a Matching Program 190 having one or more program Modules, for example, Modules A-F, for execution by the processor. One or more of the Modules A-F may be in communication with components of the Database 110 to load, modify, and store information pertaining to brands, products, services, users, and personalities. The brands, products, services, users, and personalities, may have corresponding digital records stored in and/or accessible by the Database 110.

In an embodiment, the Matching Program 190 may match a brand, product, or service to one or more users based, in part, on estimating one or more modelling parameters corresponding to a set of brand-user pairs (or product-user pairs, or service-user pairs), hereinafter referred to as a “BPS-U pair”, where the brand and user in each BPS-U pair have a known association, for example, the user has previously purchased the brand, provided an online review of the brand, or responded to a survey about the brand. Based on the estimated modelling parameters, the Matching Program 190 may determine correlations between brands and users in other BPS-U pairs, where elements of the other BPS-U pairs do not have a known association.

In an embodiment, the modelling parameters may include one or more User-Brand Affinity Parameters 150 (or user-product, or user-service affinity parameters), which may provide an indication of the level of correlation between the personalities associated with a brand and a user. In an embodiment, the correlations between brands and users (or products and users, or services and users) having no known associations, may include determining a set of User-Brand Affinity Scores 160 (or user-product, or user-service affinity scores) for BPS-U pairs of based using the estimated User-Brand Affinity Parameters 150.

In an embodiment, the Matching Program 190 may match pairs of brands (or products or services) and users having no known (or assigned) personalities and having no known (or assigned) associations with one another, based on the determined correlations between other user-brand pairs. For example, the Matching Program 190 may generate a logical User-Brand Affinity Map 170 (or user-product, or user-service affinity maps) for BPS-U pairs having known associations, and may use it to make additional matches between BPS-U pairs having no known associations.

In various embodiments, the Matching Program 190 may, based on their respective personality scales, match a given user to, or recommend to a given user, one or more brands, products, or services, or match a given brand, product, or service, to one or more users. In a further embodiment, known personality scales of one or more users and one or more brands, products, or services, may be used to match users having unknown personality scales to brands, products, or services having known personality sales; or to match brands, products, or services having unknown personality scales to users having known personality scales.

In an embodiment, the Database 110 may include the following record categories: Personalities 140, Brands 120, Products 195, Services 198, and Users 130. Each of these record categories is described below. Additionally, the Database 110 may include a set of Associations 196, which are defined in more detail, below.

Personality 140 records (e.g., P₁-Pₖ)—A Personality 140 record, or a personality, may correspond to a digital record, such as a string, number, Boolean value, or other digital value, that may be associated with a Brand 120 record and/or a User 130 record. A Personality 140 record may describe a trait, property or characteristic that may be associated with a brand, product, service, or a user. In an embodiment, the traits, properties or characteristics used to describe a brand product, or service may be the same ones used to describe a natural person. For example, the Personalities 140 may include one or more of the following:
Glamorous, secure, outgoing, sweet, exciting, elegant, mischievous, cheerful, mature, natural, rigorous, and reliable.

The Personalities 140 need not be adjectives; they may be terms associated with properties or characteristics. For example, they may include:
Glamour, excite, cheer, nature, rigor, reliance.

One or more Personalities 140 may be associated with one or more Brands 120, Products 195, Services 198, and Users 130.

Brands 120 records (e.g., B₁-Bᵢ)—A Brand 120 record, or a brand, may correspond to a digitally stored record in the Database 110, including a vector of personalities, associated with a brand. The Brand 120 may also include a vector of products and/or services associated with the Brand 120. The Brand 120 may also include a vector of users having a defined association with the Brand 120. The Brand 120 may also include additional information about the brand.

Products 195 records (e.g., Pr₁-Prₙ)—A Product 195 record, or a product, may correspond to a digitally stored record in the Database 110, associated with a product that is associated with a brand. The Product 195 record may also include a vector of users having a defined association with the Product 195. The Products 195 may also include a variety of other information about a given product, including for example, its associated brand, associated personalities, physical properties, intended use, price, availability, and other information.

Services 198 records (e.g., S₁-S_{q})—A Service 198 record, or a service, may correspond to a digitally stored record in the Database 110, associated with a service that are associated with a brand. The Service 198 record may also include a vector of users having a defined association with the Service 198. The Service 198 may also include a variety of other information about a given service, including for example, its associated brand, associated personalities, descriptions, intended use, price, availability, and other information.

Users 130 records (e.g., U₁-Uⱼ)—A User 130 record, or a user, may correspond to a digitally stored record in the Database 110, including a vector of personalities, having a defined association with an actual or potential user of the Matching System 100. The User 130 may include a variety of additional information including, for example, personalities associated with the user. The User 130 may also include a vector of brands, products, services, or a combination thereof, associated with the User 130. In an embodiment, the user may be a natural person in communication with the Matching System 100 through an I/O interface, or an automated system or device having a distinct digital signature from other systems or devices in communication with the Matching System 100. Such communication is not necessary to the operation of the Matching System 100, and where it exists, it need not be continuous. In an embodiment, a user may be a potential user of the Matching System 100 corresponding to a natural person or an automated system or device having had no communication with the Matching System 100. In another embodiment, the Matching System 100 may match users to brands without communicating with any users at all.

The Associations 196 may be a defined set of known, ascertained, or defined relationships that may exist between a pair of a Brand 120 and a User 130, a pair of a Product 195 and a User 130, or a pair of a Service 198 and a User 130. Non-limiting examples of defined associations include:
Transactional relationship—Where a User 130 purchases a Product 195, the User 130 may be associated with the Product 195. Where the Product 195 is identified by a Brand 120, the User 130 may also be associated with the Brand 120;
Opinion expression—Where the User 130 expresses an opinion regarding the Brand 120 or a Product 195 or Service 198 identified by the Brand 120, in an online review, social media platform, email communication, etc., the User 130 may be associated with that Product 195, Service 198, and/or Brand 120. For example, the User 130 may “like” a posting about the Product 195 or the Brand 120, or may rate an entry about the Product 195 or the Brand 120 on an online retailer's website.
Survey results—A User 130 indicates an interest or an opinion about a Brand 120 or Product 195 as part of a survey. The survey may be an electronic survey. In an embodiment, the User's 130 survey responses in a non-electronic survey may be digitized and added to an electronic database.

The Associations 196 need not be positive. For example, a User 130 may express an unfavorable opinion about a Brand 120. The Associations 196 may include a weighting factor that determines the type of association (e.g., positive, negative, neutral, or other type of association). In determining whether a given User 130 should be matched to a Brand 120, Product 195, or Service 198, the Matching Program 190 may take into account the weighting factor. For example, where the Matching Program 190 estimates User-Brand Affinity Parameters 150, or User-Brand Affinity Scores 160 (described below), the Program may filter out pairs of Users 130 and Brands 120 where their corresponding Associations 196 are not positive.

Additional non-limiting examples of Associations 196 include: Boolean (e.g., associated vs. unassociated); and scale/strength (e.g., 1-10).

It should be noted that while some embodiments of the present invention, described herein, refer to using known information about Brands 120, Products 195, Services 198, Users 130, and known Associations 196 between them, such information need not be used by the Matching Program 190. For example, while the Matching Program 190 may estimate User-Brand Affinity Parameters 150 based on pairs of Brands 120 and Users 130 having known Associations 196, some or all such Associations 196 may be ignored. This may be desirable, for example, where the Associations 196 are not positive (i.e., they are neutral or negative), or are otherwise undesirable. In another example, a User 130, communicating with the Matching System 100, may communicate a desire not to be receive matches to or recommendations of certain Brands 120, Products 195, or Services 198, even though User's 130 records may indicate a known Association 196 between these elements and the User 130. Therefore, in embodiments where the Brands 120 and Users 130 are described as having no known Associations 196, such associations may in fact exist, but be ignored. Similarly, where there are no known Associations 196, such associations may be generated by the Matching System 100. For example, one or more Products 195 associated with a Brand 120 may be associated, by default, with one or more Users 130, without any analysis of their associations using a data source.

The above discussion also applies to Personalities 140. For example, while a given Brand 120 may be associated with one or more Personalities 140, such Personalities 140 may be ignored. For example, for purposes of operations of the Matching System 100 and the Matching Program 190, and the claimed functions thereof, a given Brand 120 (or, for example, a given User 130) may be identified, processed, or analyzed as having no known Personalities 140, even though such Personalities 140 may have been or may be capable of being identified.

It should further be noted that while descriptions of the various embodiments of the present invention, and the claims, include references to Brands 120, Products 195, Services 198, Users 130, Personalities 140, Associations 196, and other components and data types in the plural, such references expressly contemplate singular references as well, unless specifically stated otherwise.

With continued reference to FIG. 1, the Matching Program 190 may determine, using Module A, Personalities 140 corresponding to the Brands 120, Products 195, Services 198, and to the Users 130. This determination may include accessing and loading, for further processing, pre-defined Personalities 140 for known groups of Brands 120, Products 195, and Services 198, and/or known groups of Users 130.

Alternatively, the Matching Program 190 may determine the Personalities 140 of the Brands 120, Products 195, and Services 198, and/or the Users 130, based on an analysis of information available through one or more Data Sources 180 in communication with the Matching System 100 and the Database 110. The Data Sources 180 may include, for example, and without limitation: one or more databases, servers, and the Internet. Data that may reside on the Data Sources 180 may include, for example, social media posts, electronic surveys, and other structured/unstructured digital content. Module A of the Matching Program 190 may use analytics tools to determine Personalities 140 for one or more of the Brands 120, Products 195, and Services 198, and/or Users 130. Some Brands 120, Products 195, and Services 198, and some Users 130 may have unknown personalities.

In an embodiment, the Brands 120, Products 195, and Services 198, and Users 130, their Associations 196 with one another, and their corresponding Personalities 140, may be pre-defined. In an embodiment, a provider of data analytics services may collect and maintain these records in a database. The Matching System 100 may access these records from that database as part of Module A's functions.

In another embodiment, an analytics tool may be used to determine, for a given Brand 120, Product 195, Service 198, or User 130, their Associations 196 with one another and/or their corresponding Personalities 140. For example, Matlab, RDataMining, Octave, Weka, or other proprietary or open source data analysis packages (including Java packages) may be used to mine data from a variety of sources such as social media status updates, likes, shares, ratings, reviews, comments, and other information. Java, python, or C++ codes and packages may be used to crawl the mined data to extract Personalities 140 and to determine associations. In another example, Personalities 140 and associations may be determined using a personality survey offered to Users 130 using web servers, HTML, Java scripts, Flash or other technology to provide digital surveys. All brand names and/or trademarks used herein are the property of their respective owners.

To further illustrate aspects of the present invention, an example of some Brands 120, Products 195, Users 130 and Personalities 140, and their Associations 196, are set forth below in TABLE 1. Although Services 198 are not included in TABLE 1, the relevant discussions below apply to Services 198 in the same manner as they apply to Brands 120 and Products 195.

TABLE 1
Exemplary Personalities, Brands, Products, and Users
Definitions: Personalities 140: {P₁-P₆}; Brands 120: {B₁-B₄}; Products 195: {Pr₁-Pr₄};
Users 130: {U₁-U₄}. In the example, there are six defined Personalities 140, four
defined Brands 120, four defined Products 195, and four defined Users 130.

| | | | Associated | |
|---|---|---|---|---|
| Brand/ | Associated | Associated | User/ | |
| User | Personalities | Products | Brand | Comments |
| B₁ | P₁, P₂ | Pr₁ | U₁ | B1 has two known Personalities 140, |
| | | | | and is associated with one Product 195 |
| | | | | and one User 130 |
| B₂ | P₂, P₄ | Pr₂ | U₂ | B₂ has two known Personalities 140, |
| | | | | and is associated with one Product 195 |
| | | | | and one User 130 |
| B₃ | Unknown | Pr₃ | Unknown | B₃ has unknown Personalities 140, is |
| | | | | associated with one Product 195, and is |
| | | | | not associated with any User 130 |
| B₄ | Unknown | Pr₄ | U₁ | B₄ has unknown Personalities 140, is |
| | | | | associated with one Product 195, and is |
| | | | | associated with one User 130 |
| U₁ | P₁, P₂ | Pr₁, Pr₄ | B₁, B₄ | U₁ has two known Personalities 140, |
| | | | | and is associated with two Products 195 |
| | | | | and two Brands 130 |
| U₂ | P₃, P₄ | Pr₂ | B₂ | U₂ has two known Personalities 140, |
| | | | | and is associated with one Product 195 |
| | | | | and one Brand 130 |
| U₃ | Unknown | Unknown | Unknown | U₃ has unknown Personalities 140, and |
| | | | | is not associated with any Product 195 |
| | | | | nor any Brand 130 |
| U₄ | P₁, P₂ | Unknown | Unknown | U₄ has two known Personalities 140, |
| | | | | and is not associated with any Products |
| | | | | 195 or any Brands 130 |

The Matching Program 190 may estimate User-Brand Affinity Parameters 150 for combinations of Brands 120 and Users 130 (and/or combinations of Products 195 and Users 130, or Services 198 and Users 130) using, for example, Module B. The estimate may be based on corresponding Personalities 140 that the Matching Program 190 determines using Module A for each element in each pair, and further based on known Associations 196 between the Brands 120 and the Users 130.

The User-Brand Affinity Parameters 150 may be approximated using a statistical model. In an embodiment, the statistical model may be a linear statistical model, such as a linear regression model (“Model 1”), defined as follows:
Model 1: BP˜c+w*UP
   where BP is a d-dimensional Personality 140 vector of a Brand 120, UP is a p-dimensional Personality 140 vector of a User 130 associated with the Brand 120, c is a d-dimensional vector, and w is a matrix of d×p dimensions, where c and w are two User-Brand Affinity Parameters 150.

Module B of the Matching Program 190 may use Model 1 to estimate parameters c and w using a training data set corresponding to a set of Brands 120 and a set of Users 130 (or a set of Products 195 and a set of Users 130) having known associations, as defined in the Associations 196. For example, the training data set may be based on a set of Brands 120 that include a Product 195 purchased by at least one User 130, where the Brands 120 are associated with the User(s) 130. In another example, the training data set may be based on a set of Users 130 that have purchased at least one Product 195 identified by at least one Brand 120, where the Users 130 are associated with the Brand(s) 120.

In an embodiment, using the training data set as input, Model 1 may be used to estimate parameters c and w based on multiple pairs of Brands 120 and Users 130 having known associations, as follows:
Minimize {Σᵢ(Bᵢ−c−w*Uᵢ)²+β*norm(w−w₋₁, ‘frobenius’)²}
   where Bᵢ and Uᵢ correspond to Personalities 140 of the i^{th} Brand 120 and User 130, respectively; w is a matrix, as defined above, for a given pair of Bᵢ-Uᵢ, w₋₁ is a matrix for the pair of Bᵢ₋₁-Uᵢ₋₁, and β is a model parameter that controls how much matrix w may vary from w₋₁, and wherein the norm( ) expression computes a frobenius norm.

Referring to TABLE 1, above, the linear regression model analysis described here may be implemented to estimate parameters c and w values using two pairs of Brands 120 and Users 130: U₁-B₁, and U₂-B₂. These pairs may be used because elements of each have known Personalities 140 and known Associations 196 with one another. For example, U₁'s Association 196 with B₁ may be based on U₁ having purchased B₁ at some time in the past. U₂ may be associated with B₂ because U₂ has posted a status update on a social networking website in which U₂ has expressed a positive sentiment towards B₂. In estimating c and w, U₃₋₄ and B₃₋₄ may be ignored (i.e., not used in performing the linear regression model analysis) because one or both of them have unknown Personalities 140, and/or one or both have no known Associations 196 with one another.

The Matching Program 190 may determine User-Brand Affinity Scores 160 for pairs of Brands 120 and Users 130 using, for example, Module C, based on the User-Brand Affinity Parameters 150 determined using Module B. In an embodiment, the Matching Program 190 may use Module C to apply Model 1, defined above, to one or more BPS-U pairs having known Personalities 140, but having no known associations, using the User-Brand Affinity Parameters 150 c and w estimated using Module B (unlike in Module C, parameters c and w are determined using Model 1 in Module B based on pairs of Brands 120 and Users 130 that have known Personalities 140 and known Associations 196). In an embodiment, the more similar the Personalities 140 of the Brand 120 in a given pair are to the Personalities 140 of the User 130 in the pair, as determined using c and w according to Model 1, the higher the corresponding User-Brand Affinity Score 160 may be for that given pair.

The correlation between the Personalities 140 of the Brand 120 in a given, pair and the Personalities 140 of the User 130, may be determined using a similarity measure. The similarity measure may include, for example, a cosine similarity measure, or any divergence criteria, such as a Bregman divergence measure. Where the similarity measure is based on a cosine similarity, for example, the similarity measure may have a possible range of 0-1, where 0 indicates a lowest measure of similarity, and 1 indicates a highest measure of similarity.

In an embodiment, the User-Brand Affinity Score 160 may correspond directly to the similarity measure. In another embodiment, the User-Brand Affinity Score 160 may be based on the similarity measure and one or more additional factors. For example, the User-Brand Affinity Score 160 may be converted to a percentage, or modified by a weighting factor. Other modifications of the similarity measure are possible.

Referring to TABLE 1, above, the Matching Program 190 may use Module C to apply Model 1 to, for example, the pairing B₁-U₃. B₁ and U₃ each have defined Personalities 140, but no known Associations 196. B₁ and U₃ may have no known Associations 196 because there may be no known information indicating that U₃ has ever bought a Product 195 associated with B₁, and there may be no other information (e.g., opinions expressed through social media, response to a survey, etc.) that suggests any other type of defined Association 196 with B₁. Therefore, Module C may calculate a similarity measure between the Personalities 140 of B₁ and the Personalities of U₃, using Model 1. The similarity measure may equal, or be based on, a corresponding User-Brand Affinity Score 160 of the pair.

The Matching Program 190 may select, using Module D, one or more Brands 120 for matching (or for recommendation) to one or more Users 130, or one or more Users 130 for matching (or recommendation) to one or more Brands 120, based on corresponding User-Brand Affinity Scores 160 of pairs of the one or more Brands 120 and the one or more Users 130, where elements in a given pair have known Personalities 140 but no known associations.

In an embodiment, the selection may be based on the User-Brand Affinity Score 160 for a given pair of a Brand 120 and a User 130 meeting a threshold value. For example, where the User-Brand Affinity Score 160 is calculated based on a cosine similarity measure, the threshold value may be defined as 0.6, or 60%. In this embodiment, those pairs of Brands 120 and Users 130 whose corresponding User-Brand Affinity Score 160 equals or exceeds the threshold value may be selected for matching or recommendation to one another.

In another embodiment, for a given Brand 120, the selection of Users 130, to which the Brand 120 may be matched, the threshold value may be based on a top-K set of corresponding User-Brand Affinity Scores 160. The Brand 120 may be paired with a number of Users 130 with whom the Brand 120 has no known associations, and corresponding User-Brand Affinity Scores 160 may be determined for each pair, using, for example, Module C. Where K=5, for example, the Users 130 whose pairing with the Brand 120 yield a User-Brand Affinity Score 160 in the top-five User-Brand Affinity Scores 160, are selected for matching to the Brand 120.

Similarly, for a given User 130, the selection of Brands 120 to which the User 130 may be matched may be based on a top-K set of User-Brand Affinity Score 160. The User 130 may be paired with a number of Brands 130, and corresponding User-Brand Affinity Score 160 may be determined for each pair, using, for example, Module C. Where K=5, for example, the Brands 120 whose pairing with the User 130 yield a User-Brand Affinity Score 160 in the top-five User-Brand Affinity Scores 160, are selected for matching to the User 130.

In an embodiment, the value of K may be adjustable. For example, K may be adjustable by a User 130 in communication with the Matching System 100. The User 130 may indicate a preference that the User 130 be matched to top-10 Brands 120 to which the User 130 has no known connections. The User 130 may modify the preference by selecting a new K value.

In an embodiment, Module D may filter any selection made according to any of the above-described embodiments, such that a selected set of Brands 120 or a selected set of Users 130 includes, or excludes, one or more elements based on a filtering criteria. For example, where the selection is made based on User-Brand Affinity Scores 160 meeting a threshold value, the filtering criteria may include a requirement that at least one Brand 120 should be matched to at least one User 130, even if no User-Brand Affinity Score 160 meets a predetermined threshold value.

Referring to TABLE 1, above, the pair of B₁-U₃ may have a corresponding similarity measure of, for example, 0.65. If the threshold measure is, for example, 0.6, then Module D may select B₁ for matching to U₃, and/or it may select U₃ for matching to B₁.

The Matching Program 190 may use Module E to match or recommend Brands 120 to Users 130 and/or to match or recommend Users 130 to Brands 120, as determined by the selection performed in Module D, described above. In an embodiment, the recommendation in Module E may include updating the records of a Brand 120 and a User 130 to reflect an association. In another embodiment, the Matching Program 190 may retrieve information about a Brand 120 selected for recommendation and transmit the information to a User 130 through an I/O interface for viewing by the User 130. Referring to Example 1, above, the Matching Program 190 may retrieve information about B₁ and the Products 195 associated with B₁, and transmit them to a browser application through an I/O interface of a device in use by U₃.

In some embodiments of the disclosed invention, the Matching System 100 may match (or recommend) a Brand 120, Product 195, or Service 198, with a User 130, where either the Brand 120, Product 195, Service 198, or the User 130, have no known Personalities 140, and where the Brand 120, Product 195, or Service 198 have no known Associations 196 with the User 130.

In one such embodiment, a User 130 having known Personalities 140 may be matched to one or more Brands 120 or Products 195 having no known Personalities 140, and in some instances, having no known Associations 196 with the User 130. Accordingly to one approach, such matching may be brand-centric (or product-centric). In another approach, such matching may be user-centric.

In a brand-centric approach, the Matching Program 190 may generate a User-Brand Affinity Map 170, which may be, in one example, a logical bipartite map of pairs of Brands 120 and Users 130 that have known Personalities 140 and known associations with one another, based on corresponding User-Brand Affinity Scores 160. The Matching Program 190 may generate the User-Brand Affinity Map 170 using, for example Module F, which may provide a graph representation indicating known and determined associations, and their weights, between user and brand personalities. In User-Brand Affinity Map 170, a given Brand 120 may be connected to or associated with no more than one User 130, and vice versa. The connection may be referred to as an edge. For a given pair of a Brand 120 and a User 130, their edge may have a weight corresponding to the pair's User-Brand Affinity Score 160 (or their similarity measure), or a modified weight value based on the User-Brand Affinity Score 160. In an embodiment, a given Brand 120 that is associated with multiple Users 130 may be connected, in the User-Brand Affinity Map 170, to the User 130 relative to which the Brand 120 has the highest User-Brand Affinity Score 160. Similarly, a User 130 that is associated with multiple Brands 120 may be connected, in the User-Brand Affinity Map 170, to the Brand 120 relative to which the User 130 has the highest User-Brand Affinity Score 160.

In the brand-centric approach, the User-Brand Affinity Map 170 generated using Module F may be used to match a Brand 120 to a User 130, where at least the Brand 120 or the User 130 is not represented in the User-Brand Affinity Map 170, and where one of the Brand 120 and the User 130 has no known Personalities 140 and where neither one is associated with the other. To accomplish this, the Brands 120 in the User-Brand Affinity Map 170 may be clustered using, for example, a spectral clustering algorithm.

In one embodiment, the clustering may be based on facetted attributes (or attributes, or facets) of the Brands 120 of the User-Brand Affinity Map 170. For a given Brand 120, its faceted attributes may include, for example, and without limitation: categories of Product 195 types associated with the Brand 120 (e.g., the Brand 120 may be associated with winter clothing products); price ranges of Products 195 associated with the Brand 120; descriptions of the Brand 120; and geographical markets associated with the Brand 120 (e.g., countries where Products 195 associated with the Brand 120 are sold). In another embodiment, where the bipartite graph represents connections between Products 195 and Users 130, the clustering may be based on faceted attributes of the Products 195. Faceted attributes of the Products 195 may include, for example, and without limitation: price; product specification, including physical properties (e.g., size, material composition, color); availability; and sale/discount status.

In the brand-centric approach, for a given Brand 120 (or Product 195) having no known Personalities 140, the Matching Program 190 may determine a similarity measure for pairings of the Brand 120 and one or more of the Brand 120 clusters identified in Module F. This similarity measure may be referred to as a “cluster similarity measure”. In an embodiment, the Matching Program 190 may assign a group personality scale to each cluster based on the Personalities 140 of individual Brands 120 in the cluster. For example, the group personality scale may correspond to the top-K most occurring Personalities 140 within the cluster. The group personality scale, which may include one or more Personalities 140, may be assigned to the Personalities 140 of the Brand 120 which, prior to such assignment, has no known Personalities 140.

In the brand-centric approach, the Matching Program 190 may use the group personality scale assigned to the Brand 120 that previously had no known Personalities 140 to select for recommendation that Brand 120 to one or more Users 130. The Matching Program 190 may pair the Brand 120 having the assigned group personality scale with one or more Users 130 having known Personality Scales, and no known associations with the Brand 120, and calculate corresponding User-Brand Affinity Scores 160, using, for example, Module C. The Matching Program 190 may then use Module D to select one or more Users 130 for matching or recommendation to the Brand 120.

Alternatively, if the group personalities assigned to the Brand 120 are the same as or similar to the Personalities 140 of one or more other Brands 120 that have known Personalities 120 (for example, Brands 120 represented in the User-Brand Affinity Map 170), the Brand 120 having the group personalities may be matched to the same Users 130 to which the other Brands 120 are matched. The degree of such similarity may be configurable, including by a User 130.

Referring to TABLE 1, above, in the brand-centric approach, the Matching Program 190 may determine whether to match or recommend B₃ to U₁. U₁ has known Personalities 140, and no known Associations 196 with B₃. B₃ has no known Personalities 140. In this example, the Matching Program 190 clusters B₃ with other Brands 120 based on their facetted attributes, or facets. The clustering process may identify B₃ as being in a cluster with, for example, B₁. The Matching Program 190 may match B₃ to the same Users 130 to which Bᵢ is matched. In this example, the matching may be with U₁. Accordingly, the Matching Program 190 may match B₃ with U₁.

In the user-centric approach, the Matching Program 190 may match a Brand 120 to one or more Users 130 having no known Associations 196 with the Brand 120 (“unassociated Users 130”), where the Brand 120 has known Associations 196 with one or more other Users 130 (“associated Users 130”), and where the Brand 120 has no known Personalities 140. The Matching Program 190 may identify one or more unassociated Users 130 that are similar to the associated Users 130. In one embodiment, the identification may be based on shared or similar Personalities 140 of the unassociated/associated Users 130. In another embodiment, the identification may be based on shared demographics of the unassociated/associated Users 130. For example, such demographics may include age and gender. Users 130 having the same or similar age, gender, or other demographics, may be identified as similar.

In the user-centric approach, the Matching Program 190 may match or recommend the Brand 120 to those unassociated Users 130 that are identified as similar to associated Users 130.

Referring to TABLE 1, above, the Matching Program 190 may identify, using the user-centric approach, one or more Users 130 with whom B₄ may be matched. Since B₄ has no known Personalities 140, the Matching Program 190 may be unable to match it to one or more unassociated Users 130 based on Personalities 140 matching, alone. The Matching Program 190 may, in this example, determine which one or more Users 130 are associated with B₄: here, the only associated User 130 is U₁. The Matching Program 190 may identify other Users 130 that are unassociated with B₄ but similar to U₁. For example, the Matching Program 190 may identify U₄, which has no known Associations 196 with B₄, but is similar to U₁ (they both have the same or similar Personalities 130; or they may have similar demographics). Accordingly, the Matching Program 190 may match B₄ to U₄.

Embodiments of the present invention may also match/recommend groups of Users 130 with/to one or more Brands 120 based on corresponding group attributes, including group Personalities 140. In one approach, Personalities 140 of a group of Users 130 may be aggregated, and each User 130 may be associated with one such group. Personalities 140 of a group of Brands 120 also may be aggregated, and each Brand 120 may be associated with one such group. Corresponding User-Brand Affinity Parameters 150 may be estimated, using, for example, Module B, based on the group Personalities 140. Thereafter, User-Brand Affinity Scores 160 may be calculated based on pairs of Users 120 and Brands 130, and based on the User-Brand Affinity Parameters 150 estimated based on the Personalities 140 of the groups.

In another approach, the Users 130 in the User-Brand Affinity Map 170 may be clustered using a clustering algorithm. The Users 130 and Brands 120 may also be grouped, as described above, based on their Personalities 140. The clustering may be based on facets of the Users 130. In an embodiment, the facets may correspond to demographic information of the Users 130, such as age, gender, income, interests, shopping habits, and other information. Each User 130 may be identified with a group. The clusters may be ranked according to how many Users 130 in the cluster belong to the same group. In this approach, the Matching Program 190 may select, for each User 130 in the group, one or more Brands 120 for matching or recommending to that User 130, as described above in connection with Module D. From amongst the selected Brands 120 for recommendation, the Matching Program 190 may refine its selection to include those Brands 120 that have been selected for the top-K set of Users 130, or those Brands 120 that have been selected a number of times exceeding a threshold value.

The Matching Program 190 may also make group matches or recommendations based on a probabilistic approach. In the probabilistic approach, the Matching Program 190 may generally match a User 130 to a Brand 120 based on a probability distribution function L˜(P, σ), where L may be a Gaussian distribution function, and P (corresponding to Personalities 140 of a given User 130) and σ are parameters of the Gaussian distribution, i.e., standard deviation. Using L˜(P, σ), the Matching Program 190 may select for recommendation those Brands 120 (or Products 195 or Services 198) that maximize the joint likelihood value for a group of Users 130. In another embodiment, the probability may be based on minimizing a Bregman divergence measure for groups of Users 130, and selecting for recommendation, for a given group of Users 130, those Brands 120 having a desired Bregman divergence measure that meets a threshold value.

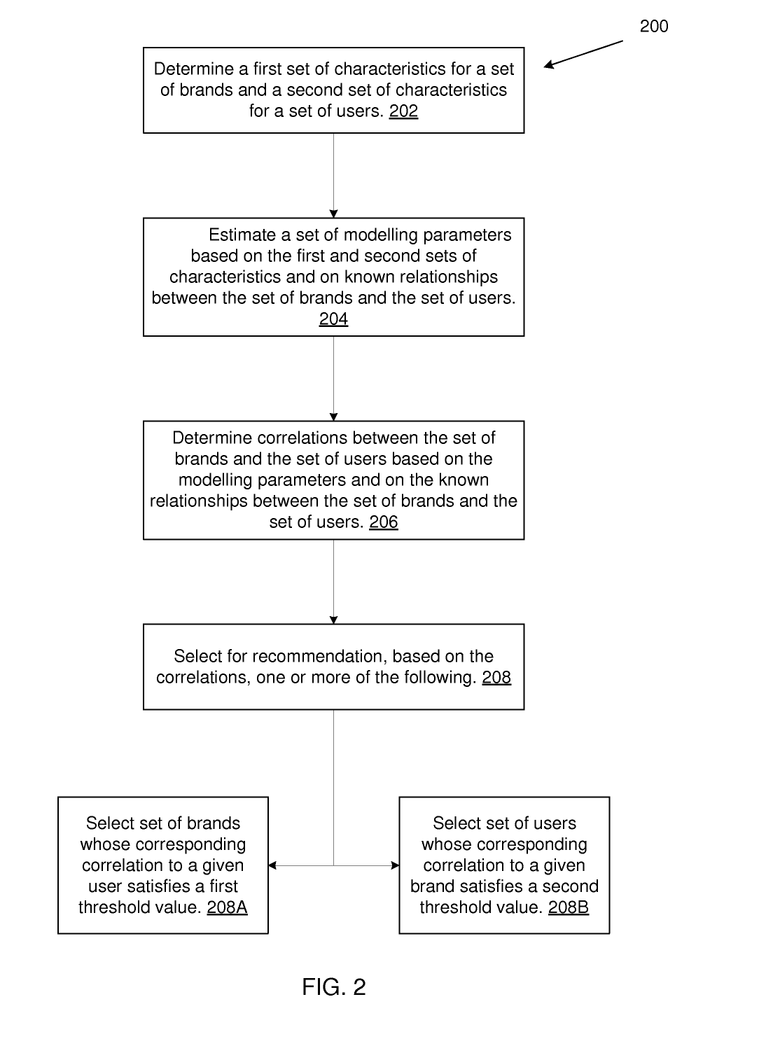

FIG. 2 is a flow chart depicting steps of a method 200 according to an aspect of the present disclosure. In an embodiment, the method 200 may include, for example, a method, routine, subroutine, or a module, or a combination thereof, which is incorporated into the Matching Program 190 described above in connection with FIG. 1, and executed by a processor.

Referring now to FIGS. 1-2, the method 200 may determine, in step 202, a first set of characteristics for a set of brands, for example, the Brands 120, and a second set of characteristics for a set of users, for example, the Users 130. The first and second set of characteristics may correspond to respective personality scales, including, for example, Personalities 140, of the Brands 120 and the Users 130. The determination in step 202 may be performed, for example, using Module A of the Matching Program 190. The determination may be based on defined or ascertained Personalities 140 of the Brands 120 and Users 130.

Based on the determination in step 202, the method 200 may use Module B, in step 204, to estimate a set of modelling parameters based on the first and second sets of characteristics and based on known associations (e.g., Associations 196) between the set of brands and the set of users. The modelling parameters may be estimated according to Model 1, described in connection with FIG. 1, above, whereby Brands 120 and Users 130 that have known Associations 196 are paired and used in Model 1 (BP˜c+w*UP) to determine corresponding c and w values. These values may be calculated for a set of BPS-U pairs (i.e., pairs of Brands 120, Products 195, or Services 198, and Users 130) and calculated for a set of pairs (e.g., for all pairs) according to: Minimize {Σᵢ(Bᵢ−c−w*Uᵢ)²+β*norm(w−w₋₁, ‘frobenius’)²}, as described above.

The method 200 may use Module C, in step 206, to determine correlations between the set of brands and the set of users based on the modelling parameters estimated in step 204 and based on known associations between the set of brands and the set of users. These correlations may include one or more User-Brand Affinity Scores 160, as described above in connection with FIG. 1. In one embodiment, the User-Brand Affinity Scores 160 may be determined for BPS-U pairs having known Personalities 140 but no known Associations 196.

The method 200 may use Module D, in step 208, to select for recommendation or for matching, correlated brands, products, or services, and users, based on the correlations determined in step 206. For example, the method 200 may, in step 208A, select for recommendation to a given user, a set of brands whose corresponding correlation to the given user satisfies a first threshold value. Alternatively, or in addition to such selection, the method 200 may select, in step 208B, a set of users for matching to a given brand, based on the correlations of the selected users to the brands satisfying a second threshold value. The first and second threshold values may be the same threshold value, or a different threshold value. For example, one or both of the first and second threshold values may be as follows: users/brands having top-K correlation values may be selected for matching to one another; users-brands having a correlation value equal to (or equal to or greater, or less than, or equal to or less than) a threshold value may be selected for recommendation. These are merely examples and do not limit the form of the threshold value or the threshold criteria that may be used to match or recommend brands and users to one another.

In other steps (not shown), the method 200 may communicate the selection made in steps 208A and 208B to, for example, a user. The communication may include, in one embodiment, presenting the selection in a listing in an HTML document configured for opening on a web browser application on a device through which the user may communicate with the method 200. In another embodiment, the method 200 may store its output, including a record of the selections for matching or recommendation that the method 200 has made, on a tangible storage medium.

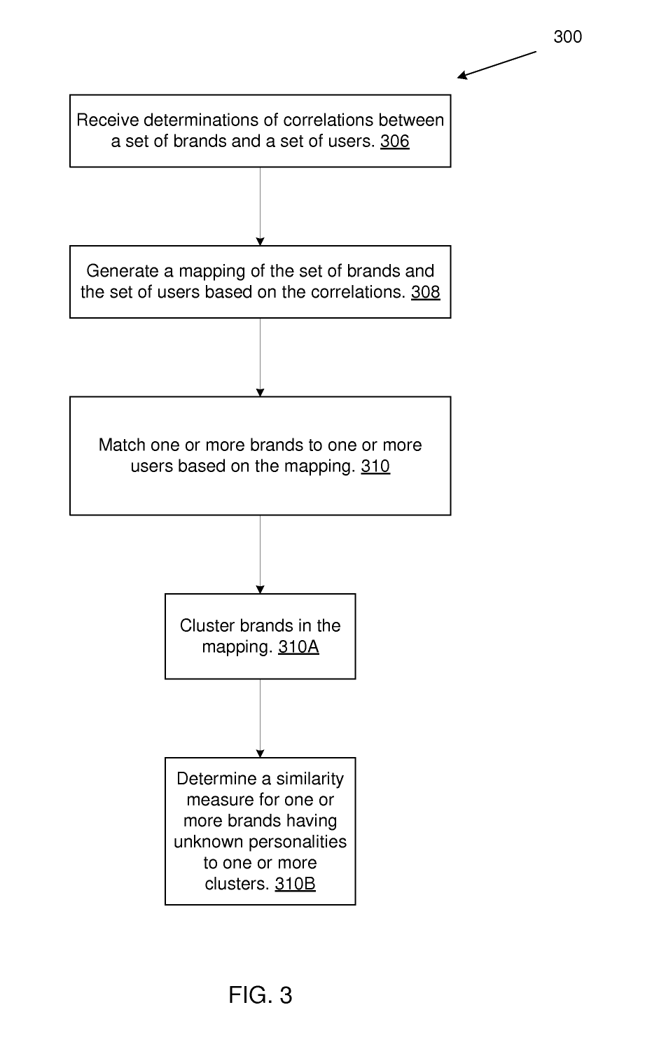

FIG. 3 is a flowchart depicting steps of a method 300, according to an embodiment of the present invention, for a brand-centric matching of a brand, product, or service to a user, where either the brand, product, or service, or the user, have no known personalities, and where the brand, product, or service have no known associations with the user. The method 300 may be, in an embodiment, an extension of the method 200 described in connection with FIG. 2, above.

Referring now to FIGS. 1 and 3, the method 300 may match a User 130 having known Personalities 140 to one or more Brands 120, Products 195, or Services 198, based on a brand-centric approach, where the Brands 120, Products 195, or Services 198 have no known Personalities 140, and in some instances, have no known Associations 196 with the User 130.

The method 300 may receive, in step 306, the correlations between a set of Brands 120 and a set of Users 130 determined in step 206 of the method 200 (FIG. 2) based on corresponding modelling parameters that are determined using a statistical model. The correlations received in step 306 may include, for example, User-Brand Affinity Scores 160.

Based on the User-Brand Affinity Scores 160, the method 300 may generate, in step 308, a User-Brand Affinity Map 170, which may be, in one example, a logical bipartite map of pairs of Brands 120 and Users 130 that have known Personalities 140 and known Associations 196 with one another. The method 300 may generate the User-Brand Affinity Map 170 using, for example Module F of the Matching Program 190. In User-Brand Affinity Map 170, a given Brand 120 may be connected to or associated with no more than one User 130, and vice versa. The connection may be referred to as an edge. For a given pair of a Brand 120 and a User 130 (or any other BPS-U pair), their edge may have a weight corresponding to the pair's User-Brand Affinity Score 160, or a modified weight value based on the User-Brand Affinity Score 160. In an embodiment, a given Brand 120 that is associated with multiple Users 130 may be connected, in the User-Brand Affinity Map 170, to the User 130 relative to which the Brand 120 has the highest User-Brand Affinity Score 160. Similarly, a User 130 that is associated with multiple Brands 120 may be connected, in the User-Brand Affinity Map 170, to the Brand 120 relative to which the User 130 has the highest User-Brand Affinity Score 160.

In step 310, the method 300 may match a Brand 120 to a User 130 based on the User-Brand Affinity Map 170 generated in step 310, where at least the Brand 120 or the User 130 is not represented in the User-Brand Affinity Map 170, and where one of the Brand 120 and the User 130 has no known Personalities 140 and where neither one is associated with the other.

To accomplish the matching performed in step 310, the method 300 may cluster the Brands 120 in the User-Brand Affinity Map 170 in step 310A using, for example, a spectral clustering algorithm.

In one embodiment, the clustering in step 310A may be performed based on faceted attributes of the Brands 120 of the User-Brand Affinity Map 170. For a given Brand 120, its faceted attributes may include, for example, and without limitation: categories of Product 195 types associated with the Brand 120 (e.g., the Brand 120 may be associated with winter clothing products); price ranges of Products 195 associated with the Brand 120; descriptions of the Brand 120; and geographical markets associated with the Brand 120 (e.g., countries where Products 195 associated with the Brand 120 are sold). In another embodiment, where the bipartite graph represents connections between Products 195 and Users 130, the clustering may be based on faceted attributes of the Products 195. Faceted attributes of the Products 195 may include, for example, and without limitation: price; product specification, including physical properties (e.g., size, material composition, color); availability; and sale/discount status.

For a given Brand 120 (or Product 195) having no known Personalities 140, the method 300 may determine, in step 310B, a similarity measure for pairings of the Brand 120 and one or more of the Brand 120 clusters identified in step 312A. This similarity measure may be referred to as a “cluster similarity measure”. In an embodiment, the method 300 may assign a group personality scale to each cluster based on the Personalities 140 of individual Brands 120 in the cluster. For example, the group personality scale may correspond to the top-K most occurring Personalities 140 within the cluster. The group personality scale, which may include one or more Personalities 140, may be assigned to the Personalities 140 of the Brand 120 which, prior to such assignment, has no known Personalities 140.

The method 300 may use the group personality scale assigned to the Brand 120 that previously had no known Personalities 140 to select for matching or recommendation, in step 310, that Brand 120 to one or more Users 130. The Matching Program 190 may pair the Brand 120 having the assigned group personality scale with one or more Users 130 having known Personality Scales, and no known Associations 196 with the Brand 120, and calculate corresponding User-Brand Personality Scores 160, using, for example, Module C. The Matching Program 190 may then use Module D to select one or more Users 130 for matching or recommendation to the Brand 120.

Alternatively, if the group personalities assigned to the Brand 120 are the same as or similar to the Personalities 140 of one or more other Brands 120 that have known Personalities 120 (for example, Brands 120 represented in the User-Brand Affinity Map 170), the method 300 may match the Brand 120 having the group personalities to the same Users 130 to which the other Brands 120 are matched. The degree of such similarity may be configurable, including by a User 130.

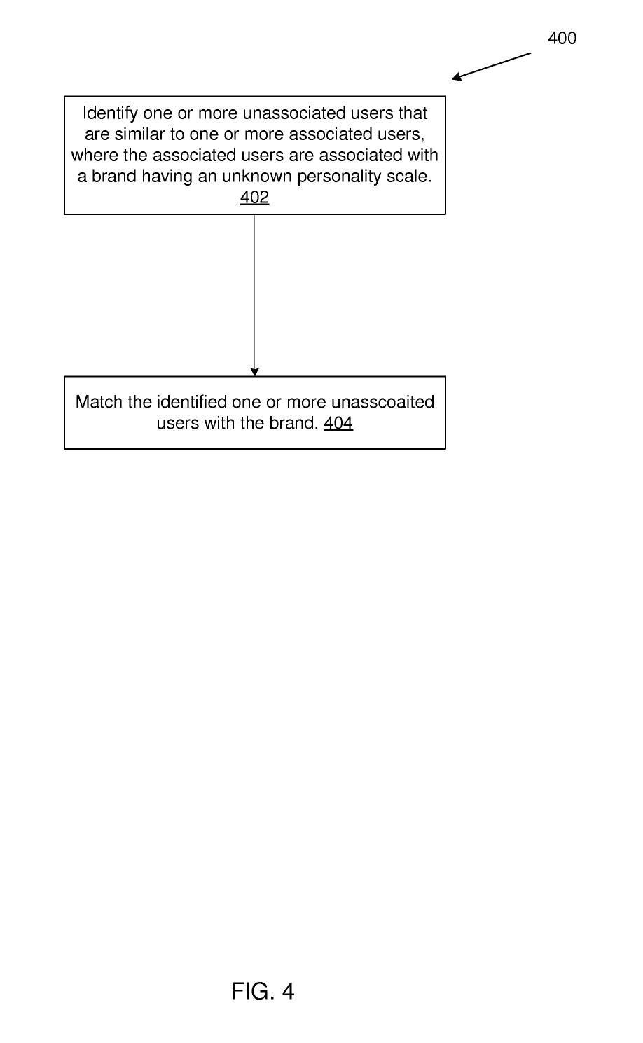

FIG. 4 is a flowchart depicting steps of a method 400, according to an embodiment of the present invention, for a user-centric matching of a brand, product, or service to a user, where either the brand, product, or service, or the user, have no known personalities, and where the brand, product, or service have no known associations with the user. The method 400 may be, in an embodiment, an extension of the method 200 described in connection with FIG. 2, above.

Referring now to FIGS. 1 and 4, the method 400 may match a Brand 120 to one or more Users 130 having no known Associations 196 with the Brand 120 (“unassociated Users 130”), where the Brand 120 has known Associations 196 with one or more other Users 130 (“associated Users 130”), and where the Brand 120 has no known Personalities 140.

The method 400 may identify, in step 402, one or more unassociated Users 130 that are similar to the associated Users 130. In one embodiment, the identification may be based on shared on similar Personalities 140 of the unassociated/associated Users 130. In another embodiment, the identification may be based on shared demographics of the unassociated/associated Users 130. For example, such demographics may include age and gender. Users 130 having the same or similar age, gender, or other demographics, may be identified as similar.

The method 400 may match or recommend the Brand 120 to those unassociated Users 130 that are identified as similar to associated Users 130, in step 404.

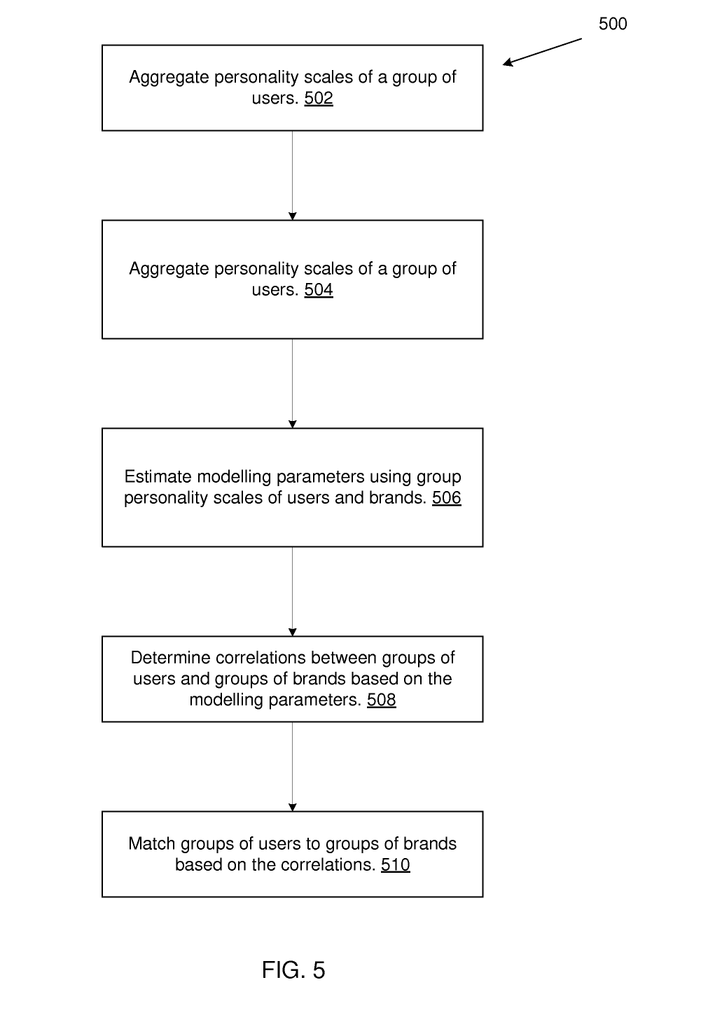

FIG. 5 is a flowchart depicting steps of a method 500, according to an embodiment of the present invention, for recommending groups of Users 130 with/to one or more Brands 120 based on their respective group attributes, including group Personalities 140. The method 500 may be, in an embodiment, an extension of the method 200 described in connection with FIG. 2, above.

Referring now to FIGS. 1 and 5, the method 500 may aggregate, in step 502, the personality scales, for example, the Personalities 140, of a group of Users 130. Each User 130 in the group may be associated with that group (for example, its record may be updated to include information about the association). The method 500 may perform the aggregation step 502 with respect to one or more User 130 groups.

In step 504, the method 500 may also aggregate the Personalities of one or more groups of Brands 120, and each Brand 120 in a group may be associated with that group.

The method 500 may, in step 506, estimate modelling parameters, for example, User-Brand Affinity Parameters 150, corresponding to pairs of user-brand groups. The modelling parameters may be, for example, c and w, and calculated according to Model 1, described above, in connection with FIGS. 1 and 2. Rather than using Personalities 140 of individual Brands 120 and individual Users 130 in Model 1, the method 500 may use Personalities 140 of groups. Which groups are paired and analyzed using Model 1 may be based on their known Associations 196 with one another (e.g., a group of Brands 120 may be associated with a group of Users 130).

The method 500 may determine, in step 508, correlations between the groups of Users 130 and Brands 120 based on the modelling parameters estimated in step 506. The determined correlations may include, for example, User-Brand Affinity Scores 160.

In step 510, the method 500 may match or recommend groups of Users 130 to groups of Brands 120 based on the correlations determined in step 508. The matching may be based on the correlations, such as the User-Brand Affinity Scores 160, meeting a threshold value.

With continued reference to FIGS. 1 and 5, in another step (not shown), the method 500 may generate a User-Brand Affinity Map 170 as described above. The method 500 may cluster the Users 130 represented in the User-Brand Affinity Map 170, using a clustering algorithm. The Users 130 and Brands 120 may also be grouped, as described above, based on their Personalities 140. The clustering may be based on facets of the Users 130. In an embodiment, the facets may correspond to demographic information of the Users 130, such as age, gender, income, interests, shopping habits, and other information. Each User 130 may be identified with a group. The clusters may be ranked according to how many Users 130 in the cluster belong to the same group. In this approach, the method 500 may select, for each User 130 in the group, one or more Brands 120 for matching or recommending to that User 130, as described above in connection with Module D of Matching Program 190. From amongst the selected Brands 120 for recommendation, the method 500 may refine its selection to include those Brands 120 that have been selected for the top-K set of Users 130, or those Brands 120 that have been selected a number of times exceeding a threshold value.

With continued reference to FIGS. 1 and 5, the method 500 may also make group matches or recommendations based on a probabilistic approach. In the probabilistic approach, the method 500 may generally match a User 130 to a Brand 120 based on a probability distribution function L˜(P, σ), where L may be a Gaussian distribution function, and P (corresponding to Personalities 140 of a given User 130) and σ are parameters of the Gaussian distribution, i.e., standard deviation. Using L˜(P, σ), the method 500 may select for recommendation those Brands 120 (or Products 195 or Services 198) that maximize the joint likelihood value for a group of Users 130. In another embodiment, the probability may be based on minimizing a Bregman divergence measure for groups of Users 130, and selecting for recommendation, for a given group of Users 130, those Brands 120 having a desired Bregman divergence measure that meets a threshold value.

Referring now to FIG. 6, a computing device 1000 may include respective sets of internal components 800 and external components 900. The computing device 1000 may be or may include, for example, the Matching System 100 depicted in FIG. 1. Each of the sets of internal components 800 includes one or more processors 820; one or more computer-readable RAMs 822; one or more computer-readable ROMs 824 on one or more buses 826; one or more operating systems 828; one or more software applications 828 (e.g., device driver modules) executing the Matching Program 190 (FIG. 1); and one or more computer-readable tangible storage devices 830. The one or more operating systems 828 and device driver modules are stored on one or more of the respective computer-readable tangible storage devices 830 for execution by one or more of the respective processors 820 via one or more of the respective RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a thin provisioning storage device, CD-ROM, DVD, SSD, memory stick, magnetic tape, magnetic disk, optical disk or semiconductor storage device. The R/W drive or interface 832 may be used to load the device driver 840 firmware, software, or microcode to tangible storage device 936 to facilitate communication with components of computing device 1000.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The operating system 828 that is associated with computing device 1000, can be downloaded to computing device 1000 from an external computer (e.g., server) via a network (for example, the Internet, a local area network or wide area network) and respective network adapters or interfaces 836. From the network adapters (or switch port adapters) or interfaces 836 and operating system 828 associated with computing device 1000 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

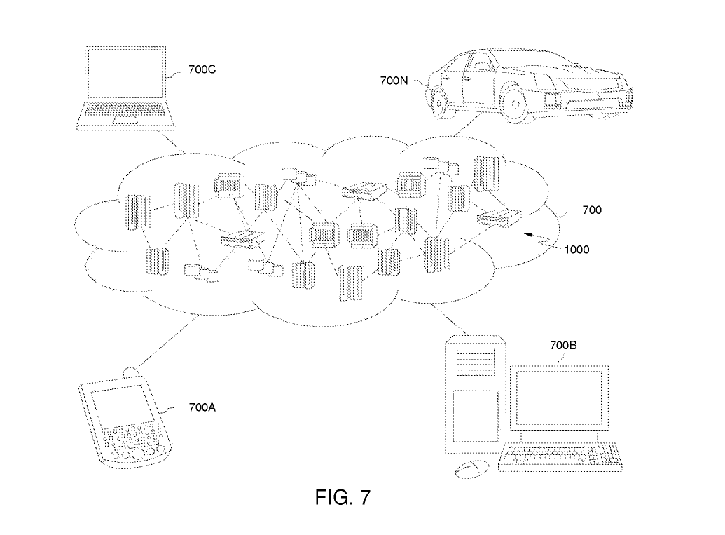

Referring now to FIG. 7, an illustrative cloud computing environment 700 is depicted. As shown, the cloud computing environment 700 comprises one or more cloud computing nodes, each of which may be a computing Matching System 100 (FIG. 1) with which local computing devices used by cloud consumers, such as, for example, a personal digital assistant (PDA) or a cellular telephone 700A, a desktop computer 700B, a laptop computer 700C, and/or an automobile computer system 700N, may communicate. The nodes 1000 may communicate with one another. They may be grouped (not shown) physically or virtually, in one or more networks, such as Private, Community, Public, or Hybrid clouds as described hereinabove, or a combination thereof. This allows the cloud computing environment 700 to offer infrastructure, platforms and/or software as services for which a cloud consumer does not need to maintain resources on a local computing device. It is understood that the types of computing devices 700A-N shown in FIG. 7 are intended to be illustrative only and that the computing nodes 1000 and the cloud computing environment 700 can communicate with any type of computerized device over any type of network and/or network addressable connection (e.g., using a web browser).

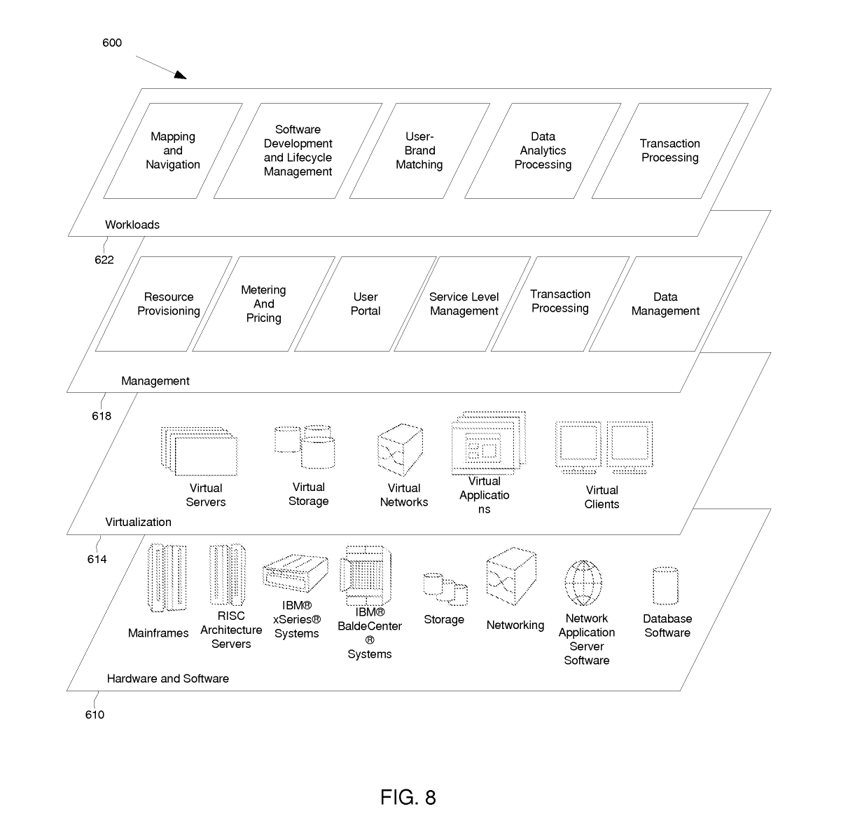

Referring now to FIG. 8, a set of functional abstraction layers 600 provided by the cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided.

The hardware and software layer 610 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

The virtualization layer 614 provides an abstraction layer from which the following examples of virtual entities may be provided: virtual servers; virtual storage; virtual networks, including virtual private networks; virtual applications and operating systems; and virtual clients.

In one example, the management layer 618 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

The workloads layer 622 provides examples of functionality for which the cloud computing environment may be utilized. Examples of workloads and functions which may be provided from this layer include: mapping and navigation; software development and lifecycle management; virtual classroom education delivery; data analytics processing; transaction processing; and user-brand (or user-product, or user-service) matching functions, such as those described above in connection with the Matching System 100, the Matching Program 190, and methods 200-500, in connection with FIGS. 1-5.

While the present invention is particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A computer implemented method for matching brands to users on a computer system, the method comprising:
determining personalities of a set of users and of a set of brands;
identifying a first set of user-brand pairs, wherein elements of each pair in the first set of user-brand pairs have known associations;
estimating one or more modelling parameters based on the first set of user-brand pairs;
identifying a second set of user-brand pairs, wherein elements of each pair in the second set of user-brand pairs have unknown associations;
determining correlations between elements of one or more pairs in the second set of user-brand pairs based on the modelling parameters; and
matching, based on the correlations, one or more of:
a select set of brands whose corresponding correlation to a given user satisfies a first threshold criteria; and
a select set of users whose corresponding correlation to a given brand satisfies a second threshold criteria;
wherein the first and second threshold criteria are identical or different.

2. The method of claim 1, wherein a brand comprises one or more of:
a source of a mark;
a product; and
a service.

3. The method of claim 1, wherein one or more of the first threshold criteria and the second threshold criteria comprises:
selecting a given brand or a given user for recommendation based on a corresponding correlation meeting at least a threshold value; and
selecting the given brand or the given user for recommendation based on the corresponding correlation being in a top-k set of correlations of the brand or of the user.

4. The method of claim 1, wherein determining the correlations comprises:
determining a correlation score based on a regression model analysis.

5. The method of claim 1, further comprising:
identifying a given user having unknown personalities, and a group of other users having known personalities, wherein the given user and the group of other users share a predetermined number of facets;
determining a set of group personalities based on the known personalities of the group of users; and
associating the set of group personalities with the given user,
wherein the steps of determining correlations and matching are performed, for the given user, based on the group personalities associated with the given user.

6. The method of claim 1, further comprising:
generating a correlation mapping between users and brands in the first set of user-brand pairs based on corresponding correlations;
generating a set of brand clusters based on brands in the correlation mapping;
identifying personalities of the set of brand clusters;
identifying a given brand having unknown personalities;
determining one or more similarity measures between the given brand and one or more brand clusters in the set of brand clusters;
matching the given brand to one or more brand clusters in the set of brand clusters based on the one or more similarity measures.

7. The method of claim 1, further comprising:
identifying a given brand having unknown personalities;
identifying a first group of users associated with the given brand;
determining group personalities for the first group of users;
identifying a second group of users sharing a predetermined number of personalities with the first group of users, wherein the second group of users is not associated with the given brand; and
matching the given brand to the second group of users.

8. A computer system for matching brands to users, comprising:
a computer device having a processor and a tangible storage device, wherein the computer is attached to a first object; and
a program embodied on the storage device for execution by the processor, the program having a plurality of program modules, the program modules including:
a first determining module configured to determine personalities of a set of users and of a set of brands;
a first identifying module configured to identify a first set of user-brand pairs, wherein elements of each pair in the first set of user-brand pairs have known associations;
an estimating module configured to estimate one or more modelling parameters based on the first set of user-brand pairs;
a second identifying module configured to identify a second set of user-brand pairs, wherein elements of each pair in the second set of user-brand pairs have unknown associations;
a second determining module configured to determine correlations between elements of one or more pairs in the second set of user-brand pairs based on the modelling parameters; and
a matching module configured to match, based on the correlations, one or more of:
a select set of brands whose corresponding correlation to a given user satisfies a first threshold criteria; and
a select set of users whose corresponding correlation to a given brand satisfies a second threshold criteria;
wherein the first and second threshold criteria are identical or different.

9. The system of claim 8, wherein a brand comprises one or more of:
a source of a mark;
a product; and
a service.

10. The system of claim 8, wherein one or more of the first threshold criteria and the second threshold criteria comprises:
selecting a given brand or a given user for recommendation based on a corresponding correlation meeting at least a threshold value; and
selecting the given brand or the given user for recommendation based on the corresponding correlation being in a top-k set of correlations of the brand or of the user.

11. The system of claim 8, wherein the second determining module is further configured to determine a correlation score based on a regression model analysis.

12. The system of claim 8, wherein the program further comprises:
a third identifying module configured to identify a given user having unknown personalities, and a group of other users having known personalities, wherein the given user and the group of other users share a predetermined number of facets;
a third determining module configured to determine a set of group personalities based on the known personalities of the group of users; and
an associating module configured to associate the set of group personalities with the given user,
wherein determining correlations and matching are performed, for the given user, based on the group personalities associated with the given user.

13. The system of claim 8, wherein the program further comprises:
a first generating module configured to generate a correlation mapping between users and brands in the first set of user-brand pairs based on corresponding correlations;
a second generating module configured to generate a set of brand clusters based on brands in the correlation mapping;
a third identifying module configured to identify a given brand having unknown personalities;
a third determining module configured to one or more similarity measures between the given brand and one or more brand clusters in the set of brand clusters; and
a further matching module configured to match the given brand to one or more brand clusters in the set of brand clusters based on the one or more similarity measures.

14. The system of claim 8, wherein the program further comprises:
a third identifying module configured to identify a given brand having unknown personalities;
a fourth identifying module configured to identify a first group of users associated with the given brand;
third determining module configured to determine group personalities for the first group of users; and
a further matching module configured to match the given brand to the second group of users.

15. A computer program product for matching brands to users, comprising a tangible storage device having program code embodied therewith, the program code executable by a processor of a computer to perform a method, the method comprising:
determining, by the processor, personalities of a set of users and of a set of brands;
identifying, by the processor, a first set of user-brand pairs, wherein elements of each pair in the first set of user-brand pairs have known associations;
estimating, by the processor, one or more modelling parameters based on the first set of user-brand pairs;
identifying, by the processor, a second set of user-brand pairs, wherein elements of each pair in the second set of user-brand pairs have unknown associations;
determining, by the processor, correlations between elements of one or more pairs in the second set of user-brand pairs based on the modelling parameters; and
matching by the processor, based on the correlations, one or more of:
a select set of brands whose corresponding correlation to a given user satisfies a first threshold criteria; and
a select set of users whose corresponding correlation to a given brand satisfies a second threshold criteria;
wherein the first and second threshold criteria are identical or different.

16. The computer program product of claim 15, wherein a brand comprises one or more of:
a source of a mark;
a product; and
a service.

17. The computer program product of claim 15, wherein one or more of the first threshold criteria and the second threshold criteria comprises:
selecting a given brand or a given user for recommendation based on a corresponding correlation meeting at least a threshold value; and
selecting the given brand or the given user for recommendation based on the corresponding correlation being in a top-k set of correlations of the brand or of the user.

18. The computer program product of claim 15, wherein the method further comprises:
identifying, by the processor, a given user having unknown personalities, and a group of other users having known personalities, wherein the given user and the group of other users share a predetermined number of facets;
determining, by the processor, a set of group personalities based on the known personalities of the group of users; and
associating, by the processor, the set of group personalities with the given user,
wherein the steps of determining correlations and matching are performed, by the processor, for the given user, based on the group personalities associated with the given user.

19. The computer program product of claim 15, wherein the method further comprises:
generating, by the processor, a correlation mapping between users and brands in the first set of user-brand pairs based on corresponding correlations;
generating, by the processor, a set of brand clusters based on brands in the correlation mapping;
identifying, by the processor, personalities of the set of brand clusters;
identifying, by the processor, a given brand having unknown personalities;
determining, by the processor, one or more similarity measures between the given brand and one or more brand clusters in the set of brand clusters; and
matching, by the processor, the given brand to one or more brand clusters in the set of brand clusters based on the one or more similarity measures.

20. The computer program product of claim 15, wherein the program further comprises:
identifying, by the processor, a given brand having unknown personalities;
identifying, by the processor, a first group of users associated with the given brand;
determining, by the processor, group personalities for the first group of users;
identifying, by the processor, a second group of users sharing a predetermined number of personalities with the first group of users, wherein the second group of users is not associated with the given brand; and
matching, by the processor, the given brand to the second group of users.
